(19) United States
(12) Patent Application Publication
(10) Pub. No.: US 2015/0149534 A1
(43) Pub. Date: May 28, 2015

(54) SYSTEMS AND METHODS FOR CREATING, DISPLAYING AND MANAGING CONTENT UNITS

(71) Applicant: Contadd Limited, London (GB)

(72) Inventor: Kleanthis Nikolaidis, London (GB)

(21) Appl. No.: 14/553,384

(22) Filed: Nov. 25, 2014

Related U.S. Application Data
(60) Provisional application No. 61/908,382, filed on Nov. 25, 2013.

(51) Int. Cl. G06F 17/30; H04L 29/08

(52) U.S. Cl. CPC G06F 17/30905; H04L 67/02
USPC 709/203

(57) ABSTRACT

The present invention involves a system which allows the creation, display, and management of content units within content, such as an image and/or video and/or photo gallery. The content unit is provided transparently through the use of iFrames and can be managed and control in real time. In general, the information provided through an iFrame may include without limitation images, icons, photographs, logotypes, videos, links and text descriptions, in different combinations. The present invention operates in the field of digital advertising, and in particular in the field of display advertising. The present invention provides the benefit of offering a new advertising display unit, which is at the same time both user initiated, provides for no intervention to the web page and can be effectively managed in real time. The present invention applies to all images and videos and photo galleries, including those on mobile applications as well as desktop applications.

### CROSS-REFERENCE TO RELATED APPLICATIONS

This application claims the benefit of U.S. Provisional Application No. 61/908,382, entitled Online Advertising Platform, which was filed on Nov. 25, 2013, the disclosure of which is incorporated herein by reference.

### FIELD OF THE INVENTION

The present disclosure is direct to systems and methods for the creation, display, and management of content units, within existing online content, and more particularly to, an online advertising system and method which provides for real-time management of the content units and enables the display of user-initiated content units using iFrames without interruption or intervention of the web page supporting the existing content.

### BACKGROUND OF THE INVENTION

Traditionally, display advertising involves a variety of delivery methods which either make use of a particular space on the web page (e.g. banner ads, skins), or superimpose and/or expand over web page content (e.g. pop up ads, floating ads) or through the use of text and hyper linking. Furthermore, traditional display advertising is displayed either without any need for the user to initiate it, or through minimal intervention by the user (e.g. mouse over). This type of display advertising tends to detract from the overall appearance of host web page which supports the original content or disrupts the user's ability to digest the original content on the host web page. Moreover, the advertising used in banners and skins typically cannot be updated or revised in real-time by the advertiser.

There is a need therefore, for a system and method for the creation, display, and management of content units (i.e., advertising), within existing web page content which provides for real-time management of the content units and enables the display of the content units using transparent iFrames and without interruption or intervention of the web page supporting the existing content and wherein the display underlying content is user-initiated.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

To achieve these and other advantages and in accordance with the purpose of the illustrated embodiments, in one embodiment, described herein are systems for the creation, display and management of content units within existing online content. The systems include, inter alia, a manager subsystem for receiving content from an end client and creating a content unit from the received content; an automation subsystem for assigning the content unit to a target website; and a statistics subsystem for providing statistics associated with use of the content unit at the target website.

In a preferred embodiment, the content received from the end client includes advertising materials. It is envisioned that the content includes articles. The articles can include any combination of text, videos, photos, photogalleries and hyperlinks.

Preferably, the manager subsystem creates an iFrame from the content. The manager subsystem can also provide the iFrame to the target website and be responsible for administering user accounts. Moreover, the manager subsystem can be adapted to create photos and/or photogalleries from the content received from the end client.

It is envisioned that the statistics subsystem can provide full or partial campaign statistics to the end client.

In certain embodiments, the content provided by the end client includes at least one photo and a thumbnail is automatically created by the manager subsystem for each photo provided.

The present invention is also directed to a method for creating, displaying and managing content units within existing online content. Preferably, the method includes, among other step, the steps of: receiving content in a database associated with a manager subsystem from an end client; creating a content unit from the received content using the manager subsystem; assigning the content unit to a target website using an automation subsystem; and providing using a statistics subsystem statistics associated with use of the content unit at the target web site.

In a preferred embodiment, the content received from the end client includes advertising materials and can be in the form of articles. The articles can include any combination of text, videos, photos, photogalleries and hyperlinks.

Preferably, the method or creating, displaying and managing content units within existing online content can further include the step of creating an iFrame from the content using the manager subsystem. Moreover, the method can include the step of providing the iFrame to the target website using the manager subsystem.

In certain embodiments of the present invention, the method can includes the steps of administering user accounts using the manager subsystem; creating photos from the content received from the end client using the manager subsystem; and creating photogalleries from the content received from the end client.

In contrast to most conventional content management and displays systems and methods, the present invention displays the content unit or advertising message, only when a user clicks on the existing content such as a video, image or photo gallery.

In particular, embodiments of the present invention are directed to a system (Platform) which allows the creation, display, and management of content units within content, such as an image and/or video and/or photo gallery. The content unit is provided transparently through the use of iFrames and can be managed and controlled through the system in real time. In general, the information provided through an iFrame may include without limitation images, icons, photographs, logotypes, videos, links and text descriptions, in different combinations.

The present invention applies to all images and videos and photo galleries, including those on mobile applications as well as desktop applications.

As will be discussed in detail hereinbelow, the advantages of the present invention include the provision of a new advertising display unit, through the content unit, which is at the same time both user initiated, provides for no intervention to the web page and can be effectively managed in real time.

### BRIEF DESCRIPTION OF THE DRAWINGS

So that those having ordinary skill in the art, to which the present embodiments pertain, will more readily understand how to employ the novel systems and methods, certain illustrated embodiments thereof will be described in detail herein-below with reference to the drawings, wherein:

FIG. 1 is a schematic overview of an embodiment of the system of the present invention illustrating several subsystems and their functions;

FIG. 2 is a process flow diagram for an embodiment of the present invention;

FIG. 3 provides a screen shot of a typical main Manager screen;

FIG. 4 provides a screen shot of a target website having a product campaign associated therewith using an in-Image iFrame;

FIG. 5 provides a screen shot of an input screen for iFrame creation;

FIG. 6 provides a screen shot of a typical output screen of the Statistics subsystem;

FIG. 7 shows the results of an export from the Statistics subsystem of a single campaign;

FIG. 8 shows the results of an export from the Statistics subsystem for multiple campaigns;

FIG. 9 provides a screen shot of a typical main screen for the Automation subsystem;

FIG. 10 provides a screen shot of the iFrame selection screen and process;

FIG. 11 provides a screen shot view of an iFrame (In-Image) as it appears on an article image, prior to the user clicking on the image, which shows a black semi-opaque bar with three keys;

FIG. 12a provides a screen shot view of an iFrame (In-Image) as it appears on an article image, upon the user clicking on the first “i” key;

FIG. 12b provides a screen shot view of an iFrame (In-Image) as it appears on an article image, upon the user clicking on the first “i” key and within the photo gallery;

FIG. 13a provides a screen shot view of an iFrame (In-Image) as it appears on an article image, upon the user clicking on the second “play” key; and

FIG. 13b provides a screen shot view of an iFrame (In-Image) as it appears on an article image, upon the user clicking on the second (‘play’) key and within the photo gallery.

These and other aspects of the subject invention will become more readily apparent to those having ordinary skill in the art from the following detailed description of the invention taken in conjunction with the drawings.

### DETAILED DESCRIPTION OF CERTAIN EMBODIMENTS

The below illustrated embodiments are directed to integrating, aggregating, displaying and utilizing data that has been retrieved from multiple data sources. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Also, the flow charts and methods described herein do not imply either required steps or a required order to the steps, and the illustrated embodiments and processes may be implemented in any order and/or combination that is practicable.

Unless defined otherwise, all technical and scientific terms used herein have the same meaning as commonly understood by one of ordinary skill in the art relating to the below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art.

It is to be appreciated the certain embodiments described herein may be utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be executed by a processor of a host computer, regardless of whether the implementation is in hardware, firmware or as a software computer product available on a disc, a memory storage device, or for download from a remote machine. The embodiments described herein include such software to implement the equations, relationships and algorithms described above.

A module, engine or like term is a functional aspect, which may include software and/or hardware. Typically, an engine encompasses the necessary components to accomplish a task. It is envisioned that the same hardware could implement a plurality of engines and portions of such hardware being available as needed to accomplish the task. One skilled in the art will appreciate further features and advantages of the certain embodiments described herein. Thus the certain embodiments are not to be understood to be limited by what has been particularly shown and described, except as indicated by the appended claims.

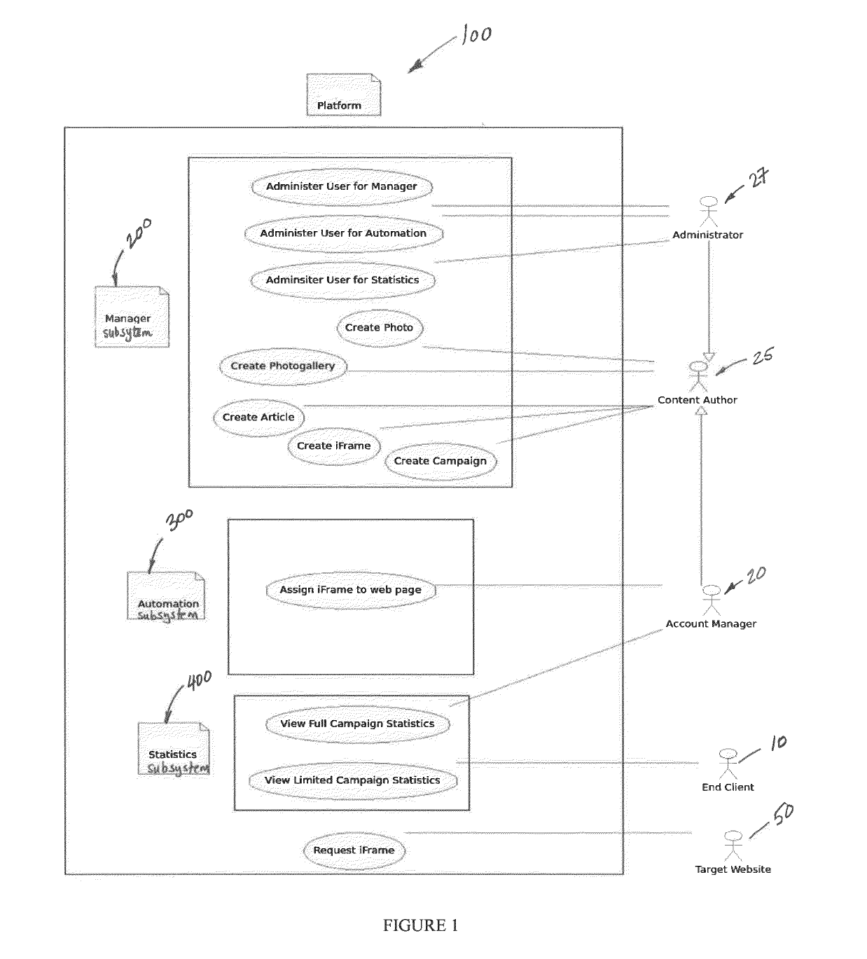

Referring to FIG. 1, there is illustrated a graphical representation of a system for the creation, display, and management of content units, within existing online content, which has been designated as reference numeral 100. In general, the aim of system 100 is to provide media-rich content units used in internet advertising. Those skilled in the art will readily appreciate that although system 100 is being described with respect to an online advertising platform, system 100 can be used in other applications to provide non-advertising based content units which are accessed by a user from a target website.

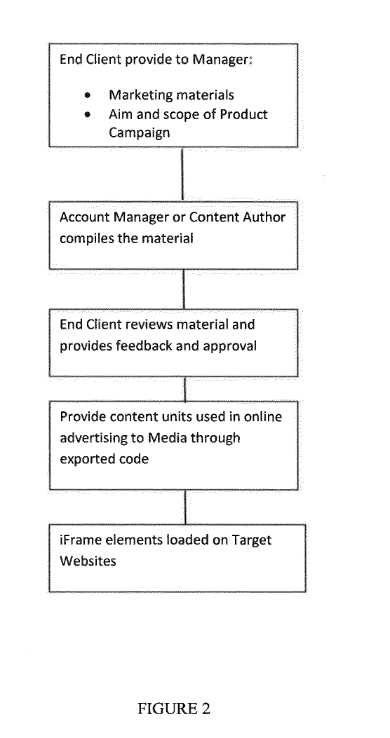

In system 100, the End Client (e.g., media shops, advertising agencies, marketing agencies and/or brands) 10 provides an account Manager 20 with the marketing material and with the general aim and scope of a particular product/services campaign. With reference to FIG. 2, Account Manager 20 can or via a Content Author 25 compile the material using system 100 as will be described herein below. Then the material/services are provided to the End Client 10 for feedback and approval. Following this, the services are provided to the Media for publication through an exported code and the use of iFrame elements on Target Websites 50.

An iFrame is an HTML document embedded inside another HTML document on a website. The iFrame HTML element is used to insert content from another source, such as an advertisement, into a web page. Although the iFrame behaves like an image on the web page, it can be configured with its own scrollbar independent of the surrounding page's scrollbar. Moreover, a web designer can change an iFrame's content without requiring the used to reload the surrounding page. This capacity can be enabled through JavaScript or the target attribute of an HTML anchor.

In addition to the iFrame creation functionality, mainly handled by the Content Author 25 or the Account Manager 20, system 100 can also provide functionality to monitor the performance of a Product/Services/Advertising Campaign.

Upon the creation of an iFrame, system 100 allows for the automated enabling and disabling of iFrame display, according to the product campaign options set by the Account Manager. Those skilled in the art will appreciate that access to systems 100 can be protected by means of a username and password combination, issued by Administrator 27 for system 100.

Based on the aforementioned functionality, system 100 can be split in three subsystems that handle the overall functionality. These three Subsystems are:

Manager (iFrame creation, management of users)—Subsystem 200

Statistics—Subsystem 300

Automation—Subsystem 400

As shown in FIG. 1, the stakeholders for system 100 are the End Client 10; Target Website 50; Account Manager 20; Content Author 25 and Administrator 25.

The last three stakeholders, Administrator 25, Account Manager 20 and Content Author 25, overlap in this version/embodiment of system 100 and these roles can be handled by any number of individuals. The Use Cases for system 100 are summarized in FIG. 1.

Manager Subsystem—200

Manager subsystem 200 allows users to create iFrames for product campaigns and is also used to manage user accounts. A product campaign is based on iFrames. The iFrame provides the in-image advertising functionality on the media originally present on the target website. As will be shown, keys on the iFrame allow the user to browse through the iFrame's articles which may contain photos, photo galleries (collection of photos), videos, text, and hyperlinks. Several combinations are allowed, for example an iFrame may contain articles having the following formats:

Article including text and a photo gallery; and

Article including videos and a photo gallery, etc.

The Manager subsystem 200 is run from a web browser and enables access only to those authorized by use of a username and a password.

In order to facilitate the creation of iFrames, the following main categories should appear on the main page of the Manager subsystem page: iFrame; Articles; Photos; Photo galleries; Media and Product Campaigns.

For each photo uploaded, a thumbnail is automatically created using the Manager subsystem 200. However, system 100 can be adapted to allow users to supply a custom thumbnail image of their choice as well. The user can also be able to define alternative text, title and description to be used with the photograph. Alternative Text is used to define the text that appears when the user's mouse pointer is over a picture. A Title field is used for searching purposes. The Description section is where the text that will appear on the right of an image is defined. This can be a rich-text field, meaning that font style, size and colour options are available, as well as the addition of images or hyperlinks via a rich-text editor. The system allows its users to edit a previously uploaded photo and its related fields.

Photo galleries are used to group photos together for usage in an article. For each photo gallery a name is set. The user is able to add photos to the photo gallery by searching based on previously defined keywords.

Two categories of photo galleries are available, “simple” and “sponsor”. A photo submitted as simple in the photo gallery does not show additional data such as description or alternative text, whereas sponsor photos appear individually on the left side of the In-Image, with their description on the right. A photo gallery is able to contain both simple and sponsor photos.

In system 100, photo galleries can be edited after they have been created in order to add or remove photos, or to change the name of the photo gallery.

Each article can be composed of for example, text, photos, photo galleries and links. For each article a Title, Short Description, Description (in Rich Text), Photo, Photo gallery, Logo, and Video/Social Media/End Client URL links will be specified. After submitting an article all the fields are able to be re-edited from corresponding options in the Manager subsystem 200.

Each iFrame is composed by one or more previously created articles. For each iFrame its Name, Title, background Photo and Video will be specified. As will be shown supra, articles are assigned to image keys that appear on the bottom of the iFrame and link to each article. Several images are available to indicate the content of the article assigned per case (e.g. clothing, video, etc.). It is possible to select scenarios for the iFrame including Landscape/Portrait view, Large/Small Banner, or the InVideo functionality.

Each product campaign consists of one or more previously created iFrames. It is possible to define the rollout of a product campaign, i.e. the dates that the campaign will be active, for statistical and categorization purposes, only by the Manager subsystem 200. The actual roll-out is handled by Automation subsystem 300. For each product campaign it is possible to set a Name, the From/To dates that the product campaign will be active, the number of engagement agreed, and keywords to aid in searching. After defining a product campaign it is possible to assign previously created iFrames to it.

The Manager subsystem 200 allows the administration of user accounts to access the Statistics and Automation Subsystems 300/200. Product campaigns are assigned to the corresponding Account Managers 20. After a user has been created, product campaigns are assigned to that user for statistical purposes. It is possible to assign a product campaign to more than one users, as there may be an overlap in responsibilities that requires such handling.

Automation Subsystem 300

The Automation subsystem 300, allows account managers 20 to assign iFrames to specific target websites 50. As noted above, system 100 is accessible via a web browser and only to certified users via a username/password combination administered in the Manager Subsystem 200.

Via system 100 it is possible to provide iFrames to target websites 50. The media wishing to participate will provide to the system 100 the webpages that are available for use as target websites 25 via an RSS feed. System 100 will register all the RSS feeds on the system's database. These database entries will be automatically updated every five minutes.

The account manager 20 selects from the target websites 25 listed in the database the ones which are to participate in a specific product campaign and assigns them to that campaign. The target websites 25 implement provided JavaScript code on their article template which results in the loading of an iFrame when one is present and active. When a product campaign ends (engagement is met), the JavaScript code stops serving the iFrame.

The account manager 20 is thus presented with two lists. The first list contains the 100 most recent Target Website articles that are available for placing campaigns. The account manager 20 is able to navigate to the live website page to assert suitability of the website article for campaign placement. The second list contains all the product campaigns that are managed by the account manager 20 and are available for assigning on target websites 25.

It is possible to edit the duration of the campaign by setting “from” and “to” dates and the agreed number of engagement. The account manager 20 also sets keywords and comments as well as a color that is used to display this campaign assignment on the RSS Feed list of website articles.

The account manager 20 is able to assign an iFrame from a product campaign to a target website by selecting the website article on the first list and a product campaign's iFrame from the second list and issuing an Assign command. Suitable visible indicators are present on the automation subsystem 300 to inform the account manager 20 of active assignments of iFrames websites.

Statistics Subsystem 400

The Statistics subsystem 400 allows End Clients 10 and Account Managers 20 to monitor the statistics of the product campaigns. The statistics subsystem 400 is accessible via a web browser and only to certified users via a username/password combination administered in the Manager subsystem 200.

The Statistics subsystem 400 of system 100 provides the following information for End Clients: Impressions; Activations; Inner Clicks; Clicks Through; and Engagements.

For Account Managers 20 the Statistics subsystem 400 provides the following additional functionality: link to the original website; iFrame statistics; and export of single and multiple product campaign statistics.

Plug In Embodiment

The present invention also offers a second method of operation, for the automatic creation and display of content units. This is provided through a Plug In extension. Effectively, this involves the creation of default content units, where no customization on the design structure can be allowed.

The Plug In allows the presentation of a website's (Source Website) elements, (which may include without limitation pictures, images, icons, text, links, video material, audio material, etc.) on another website (Target Website), over existing content, (e.g. videos and/or images and/or photogalleries). The information of the source website is presented in a default format which the system already has defined (i.e. the position of the content within the iFrame).

The Plug In allows the target websites 25 themselves to both create and display content directly on the image without making use of the Manager subsystem 200 and Automation subsystems 300. The Statistics subsystem 400 operates as previously described to the Plug In embodiment.

While these subsystems provide the benefit of the Content Author 25 and/or the Account Manager 20 having the freedom to decide on how the content units are going to be compiled and when they, will be displayed, the Plug In allows for a quicker and more direct and efficient creation and delivery of content units.

As previously noted, the Content Author 25 and/or the Account Manager 25 can customize each iFrame (e.g. crop images, change thumbnails to the video, as well as all intervene in terms of design) and remove certain features, as required by the End Client 10 or the Account Manager 20. Furthermore, these changes and customizations can occur in real time, as the system allows these updates.

The Plug In does not allow for such customizations as it provides a default layout of how the content will appear within the iFrame. This is due to the fact that this is an automated tool and that the Plug In essentially analyzes the Source Website and restructures it to fit an iFrame.

The Plug In has been developed as primarily a marketing tool, although its use may extend to all kinds of Source Websites. The Plug In applies to all images and videos and photo galleries, including those on mobile applications as well as desktop applications.

The stakeholders for the Plug In embodiment of the present invention are summarized as follows: Target Website; Source Website; Manager; and Administrator.

The implementation of the Plug In, in terms of the target website 50, requires essentially the same code as in Automation subsystem 300. It is a JavaScript based code which also uses a JSON data interchange format. The Plug In is supported through the Chrome browser, but it can be adapted for other browsers. The purpose of the installation of this code is:

to allow the transfer of data from the host system servers to Target Website; and

to allow the assignment of the data to a predefined position within the Target Website.

Secondly, the target website 50 must install the Plug In on the browser. Access to the Plug In extension is protected by means of a username and password combination, issued by the Administrator.

Upon logging in to the Plug In extension, the Account Manager 20 sees a list of the particular Source Websites/partners available. It is noted that once logged in into the Plug In extension and navigating to partner Source Websites, the system provides notification (pop-up) that this is a partner website. Equally, when navigating to non-partner Source Websites the system notifies that this is not a partner website.

The Manager may visit any of the listed Source Websites and navigate in order to find the desired URL(s). Once the Manager views a URL of interest on a Source Website, by clicking on the Plug In extension icon on the browser, he is able to save the URL as favorite. The above procedure can be followed for every single page on Source Websites.

In order for the Target Website to be able to select URL's from the Source Website, it is required that the Source Website will have been “analyzed” by the Platform.

For each Source Website the “analysis” helps identify all different HTML elements (pictures, images, text, links etc.). The analysis involves: whether there are pictures/images, whether there are social media icons, the classes, areas, positions of pictures/images, the positions of social media etc. Through this analysis, all the material and information may be compiled into an iFrame.

The compilation of the material is not made at the analysis stage. At this stage, the Plug In allows specific URL(s) to be saved as favorites. It is only when the Manager, having logged in through the Plug In, and having chosen a URL from the favorites list that the system uses the elements defined to create the Source iFrame.

In order to assign the saved URL(s), by clicking on the Plug In extension icon and then on the user name, the Manager can visit the Target Website(s) based on the log in details. This is done so as to enable the Managers to track potentially more than one Target Websites.

Once the Manager visits the Target Website, the Manager can navigate in order to find the desired Target URL, i.e. where to assign the iFrame. Once the Manager selects the Target URL, he clicks on the Plug In extension icon and a list of inputs appears. By clicking on each star icon, he can choose amongst the URL(s)/favorite(s) already saved.

Assuming that the Manager has saved specific URL(s) through the Plug In extension, by selecting the URL(s), adding a description and clicking ‘Submit’, an iFrame will appear on a predefined position on the Target Website.

The delivery of the iFrame in terms of the location within the Target Website is done in a predefined position which the Plug In provides. This means that the iFrame will always appear in a specific position within an article template (i.e. on the top image within an article, on the second image within an article, or on all images within an article). This is something which the Administrator and the Target Website decide upon and it is customizable as it depends on a website's article template.

The system allows the control over the iFrames. This time it is the responsibility of the Manager which can activate or deactivate iFrames by clicking the on/off button which appears within the Plug In extension.

Finally, the Plug In offers the Statistics Subsystem functionality. The statistics vary again according to the stakeholder in question.

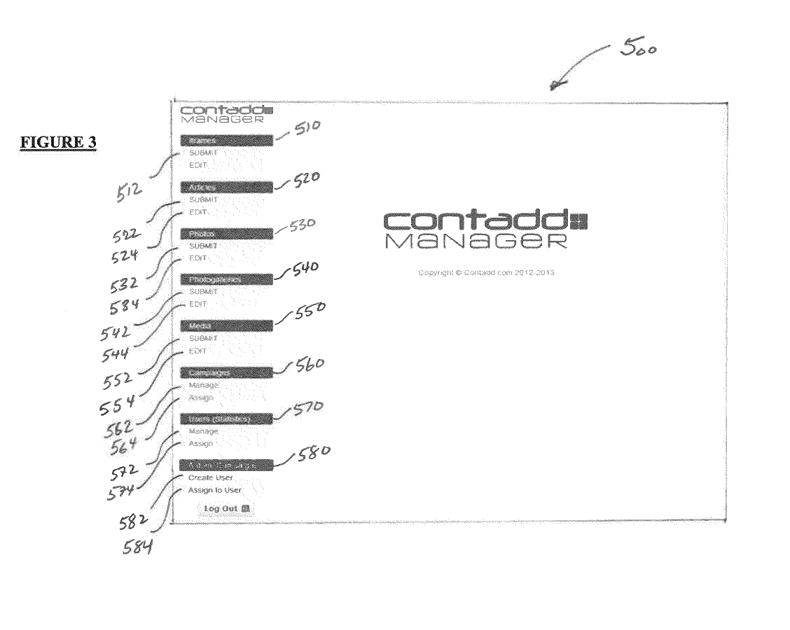

A representative method for implementing system 100 will be described below with respect to FIGS. 3 through 10. The Manager subsystem 200 allows users to handle photos, photogalleries, articles, iFrames and product campaigns. To invoke the Manager subsystem 200, the user can open a web browser at the host web site and a log-in screen will appear.

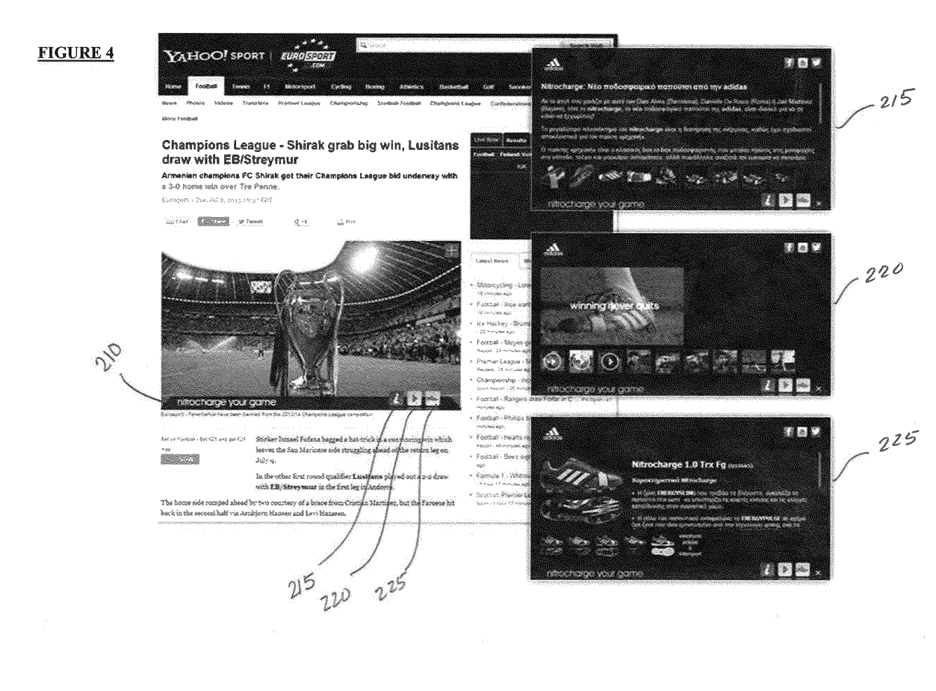

In certain embodiments of the present invention system 100 supports only a single user for the Manager subsystem. However, it will be appreciated that the system can be used simultaneously by several users at the same time. Upon entering a username and password combination supplied by the user's administrator, the main Manager screen will be shown (see FIG. 4).

As shown in this figure, the main Manager screen 500 includes a number of categories which can be selected by the user. As stated previously, a product campaign is based on iFrames and each iFrame can consist of, among other things, articles, videos, photos and photogalleries. The iFrame provides the In-Image advertising functionality on the media originally present on the target website.

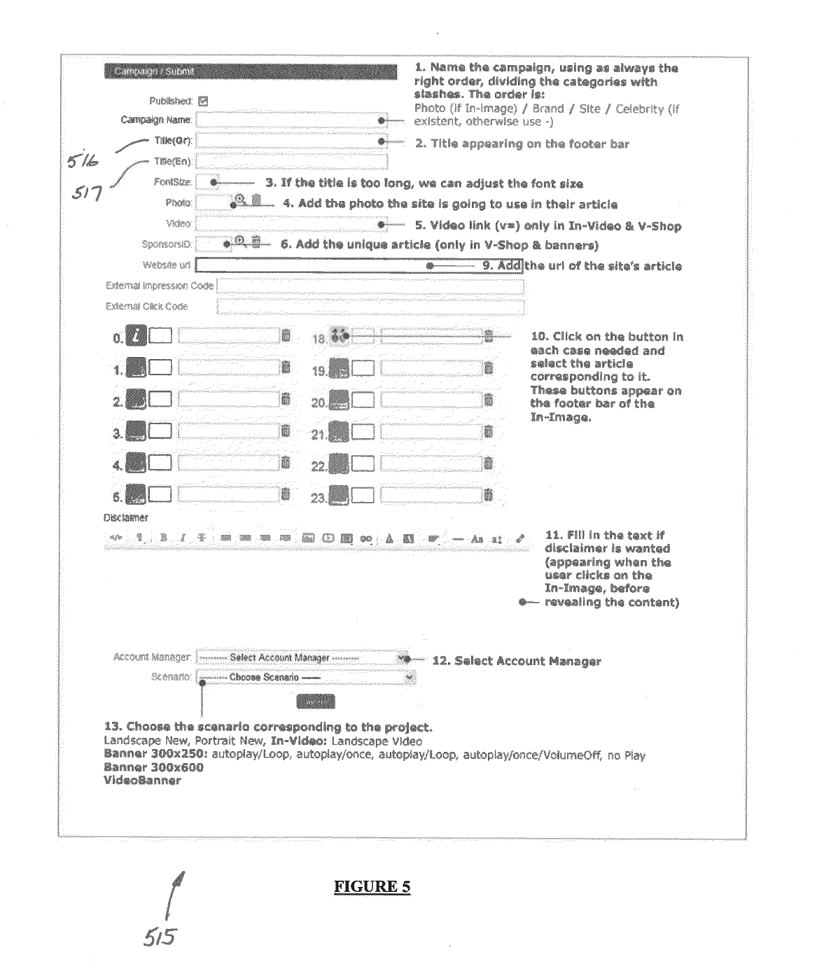

FIG. 5 provides an example iFrame and its corresponding articles. In this figure, the following is shown:

The In-Image interface over an existing website image 210;

The first article, including text and a photogallery; 215

The second article, including three videos and a photogallery; 220

The third article, marked with the shoe icon, which also includes a photogallery 225.

In order to create a new product campaign the user has to upload the campaign material, starting with a picture of the article the target site is going to use. After that the remaining photos that will be used internally, such as the brand's logo, the simple photo gallery images and the sponsor photo gallery images (e.g. products with description) can be uploaded.

There are two categories of photogalleries, “simple” and “sponsor”. A photo submitted as simple in a photogallery will not show additional data such as description or alternative text, despite those being entered when the photo was created. Such images show up in overlay, with left/right arrows to move to the previous/next photo respectively. On the other hand, sponsor photos appear individually on the left side of the In-Image, with their description on the right. A photogallery can contain both simple and sponsor photos. Sponsor photos will appear first in the In-Image.

If the iFrame produced is not intended to be delivered transparent to the target website, then the background image for the iFrame must be uploaded. Otherwise, if the iFrame is intended to be delivered transparent, then the user is advised to upload a suitable photo for use as a temporary background to assist him/her for the creation of the iFrame. All iFrames that are served via the Automation subsystem 300 are transparent, so any image uploaded as background during the iFrame creation will not show on the end client's screen.

Typically the photos submitted should be in either .jpg or .png format at 72 dpi resolution and their size should be the smallest possible. Once an image is uploaded, a thumbnail of 50×50 pixels is automatically created. If a different thumbnail is needed, then the Upload File under the Thumbnail section can be used. Alternative Text is used to define the text that appears when the user's mouse pointer is over a picture. This is an optional setting and works only on sponsor photo galleries.

In a description section the text that will appear on the right of the sponsor image is defined. This can be a rich-text field, meaning that font style, size and color options are available, as well as the addition of images or hyperlinks via the editor. Note that the image that is used within a sponsor photo is uploaded from Media section 550 of the main Manager menu 500. It is not possible to use an image that was uploaded as a Photo. After a photo is uploaded it can be edited in order to change the thumbnail, title, alternative text and description.

The Photogalleries 540 “submit” button 542 in the main Manager screen 550 can be used to compose a photogallery for an article. In order to add a photo to the photogallery, the user can click a search icon next to the appropriate photo location. A pop-up window will appear, enabling the user to enter keywords to locate the photo needed. The user may then select the correct photo from the results displayed.

Photogalleries can also be edited after they have been created in order to add or remove photos, or change the name of the photogallery by clicking on the photogalleries 540, “edit” 544 button.

Each article can be composed of text, photos, photogalleries and links. The Articles 520/Submit button 522 can be selected in order to begin the submission process. After submitting an article all the fields can be re-edited using the Article 520/Edit button 524.

The iFrames 510/Submit option 512 can be used to create a new iFrame. Once selected, an input screen 515 appears similar to that shown in FIG. 5.

There are two fields for the title, one called Title (Gr) 516 and one called Title (En) 517. Title (En) 517 should be used if the Title field contains only Latin characters, whereas the Title (Gr) 516 field should be used for titles containing also other characters of the Unicode set (e.g. Cyrillic, Greek alphabets). Note that only one of these fields must be filled in and not both.

With reference to FIG. 3, the campaign option 560 is used to define the rollout of a campaign, i.e. the dates that the campaign will be active. It is used for statistical and categorization purposes. The Campaigns 560/Assign option 564 is used to assign an iFrame/In-Image already created to a product campaign.

The User (Statistics) option 570 is used to assign product campaigns to different account managers. To create a username/password combination for an account manager the User (Statistics) 570/Manage option 572 is selected.

After a user has been created by selecting button 582, campaigns can be assigned to that user for statistical purposes using the User Statistics 580/Assign button 584 of the Manager menu 500.

The Automation Campaigns option/section 580 is used to create/manage user accounts for the Statistics 400 and the Automation 300 subsystems. Upon creating a user (i.e. account manager), it is then possible to assign Product Campaigns (not single iFrames/InImages) to each user account. It is possible to assign a product campaign to more than one user.

The Statistics subsystem 400 allows clients and account managers to monitor the statistics of the campaigns. The Statistics subsystem 400 provides the following information:
Impressions
Activations
Inner Clicks
Clicks Through
Engagements
Single Export (red bars button)
Link to the website (blue chain button)
iFrame statistics
Multiple Export

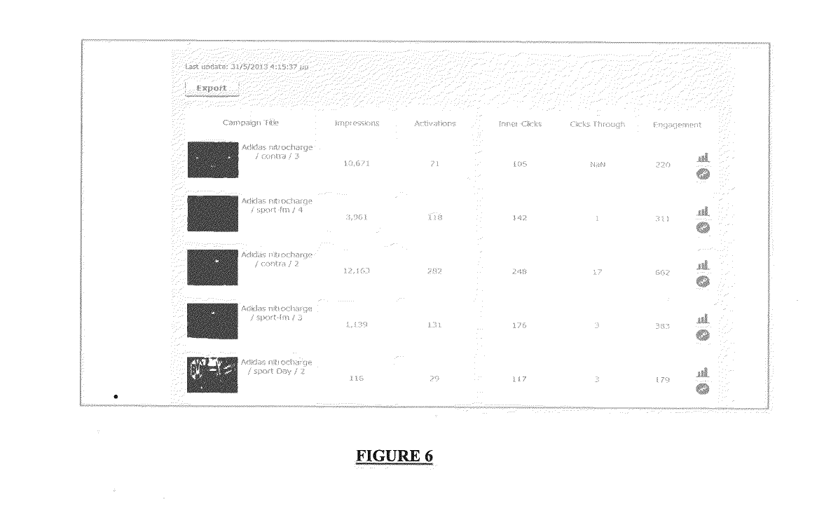

A typical output screen of the Statistics subsystem is shown in FIG. 6.

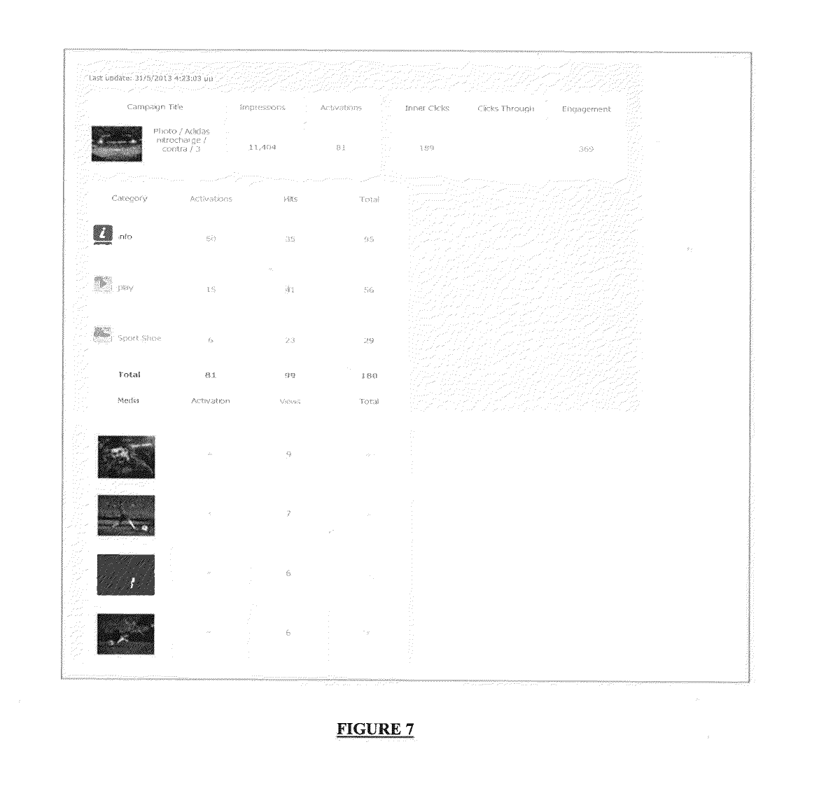

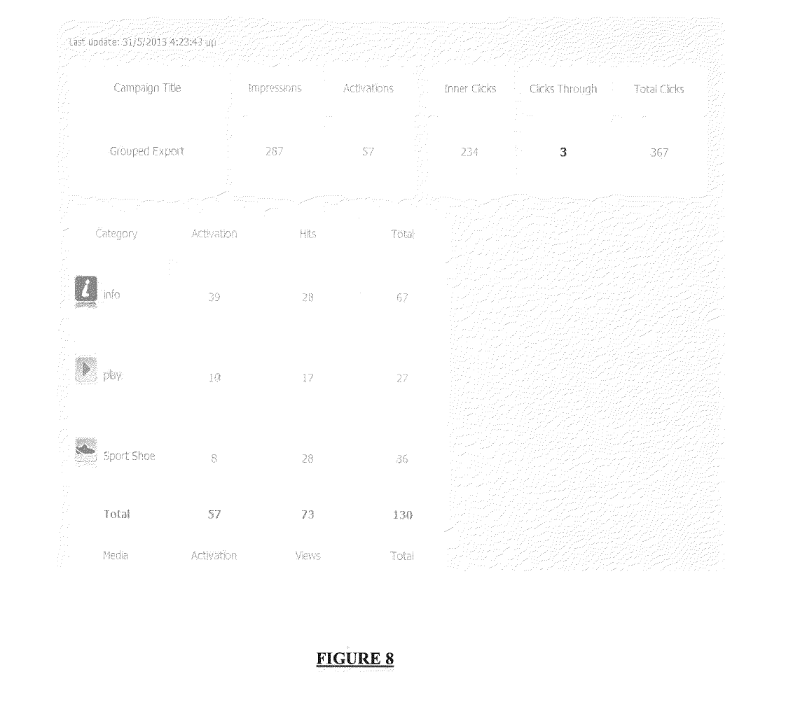

For Multiple Export the user can select the appropriate campaigns. FIG. 7 shows the results of an export of a single campaign and FIG. 8 shows the results of an export for multiple campaigns.

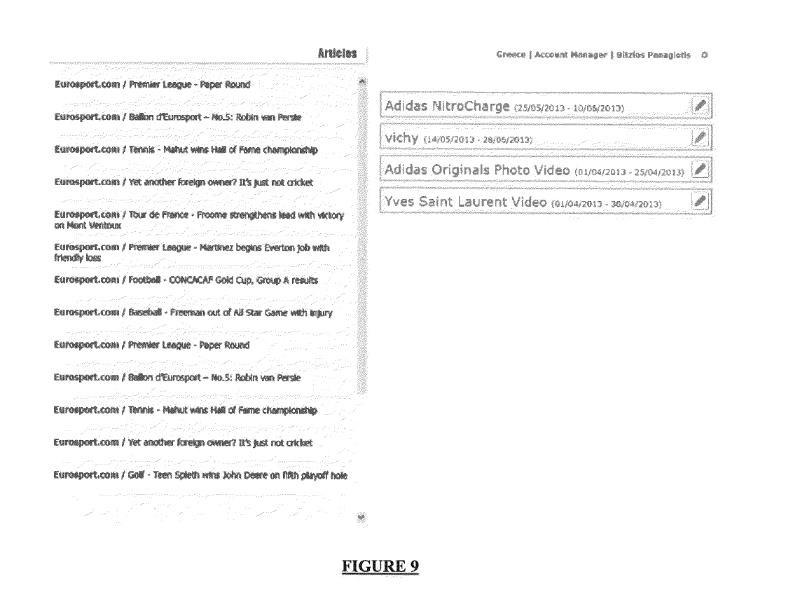

As stated previously, the Automation system 300 allows account managers to assign iFrames/InImages to specific website articles. After successfully logging in, the user is presented with two lists, as shown in FIG. 9 screen shot. The left list contains the website articles that are available for placing InImage campaigns. The user can navigate to the live website page by clicking on the bold-typed characters of the website's name. This list is automatically updated every five minutes.

The right list contains all the Product Campaigns that are managed by the account manager and are available for assigning on a website.

By clicking on the pencil icon next to a campaign it is possible to edit the duration of the campaign by setting the From and To dates, the agreed number of activations, keywords and comments as well as a color that will be used to display this campaign assignment on the RSS Feed list of website articles.

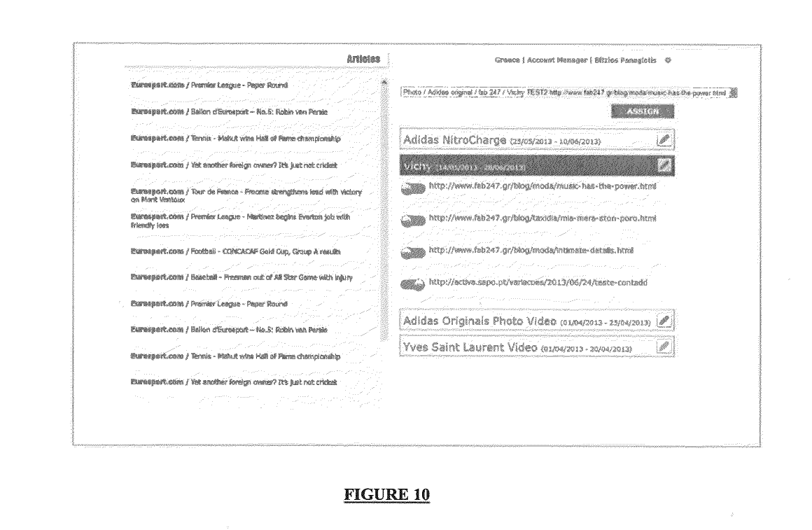

In order to assign an iFrame from a Product Campaign to a Website, the user has to identify the article that will be used by clicking on the website name in bold characters to evaluate the article's content first. Then the user must select a product campaign from the right list, then select an iFrame of the specific campaign from the drop-down list that appears above the product campaigns, click on the website article on the left list of the Automation window and press the Assign button. After successful assignment of the iFrame to the website article, a green light icon will appear next to the Product Campaign. FIG. 10 provides a screen shot of the iFrame selection screen and process.

In the automated phase system 100 provides only transparent iFrames to the media. For this to operate, the media wishing to participate must provide RSS feed in order for their website articles to appear on the Automation subsystem's list of available articles. Additionally, in the automated phase, upon agreement with the system administrator, the media must implement 3 lines of JavaScript code once on their article template.

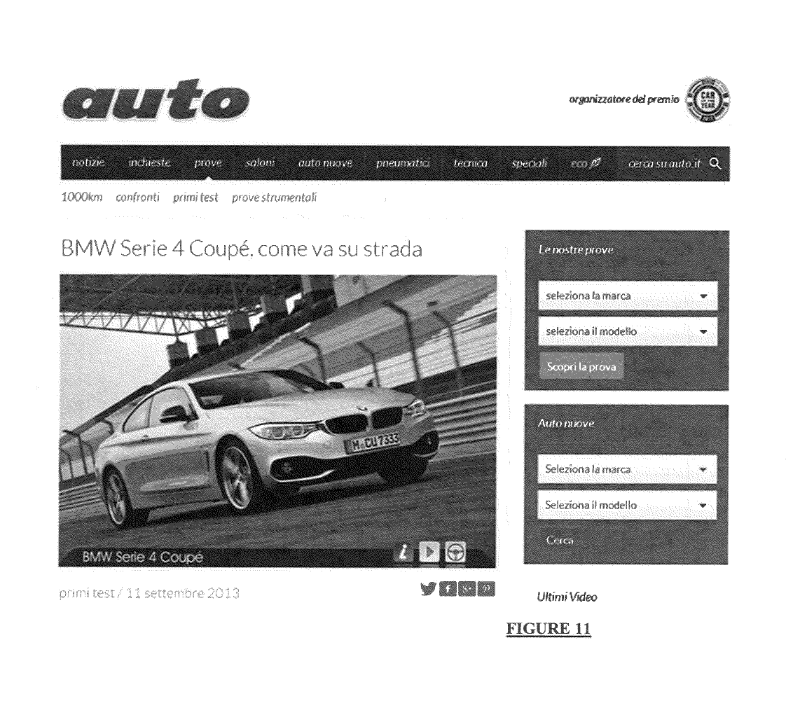

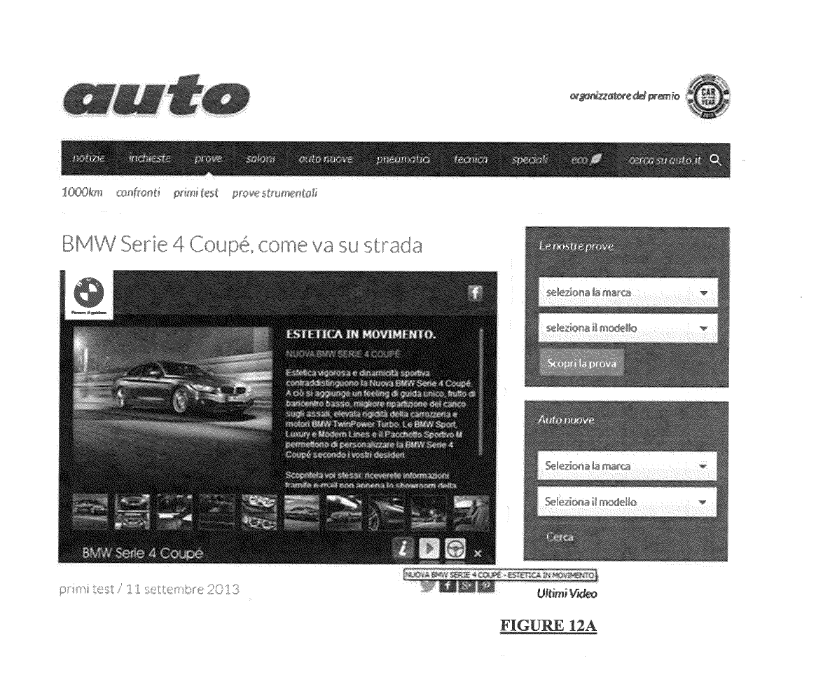

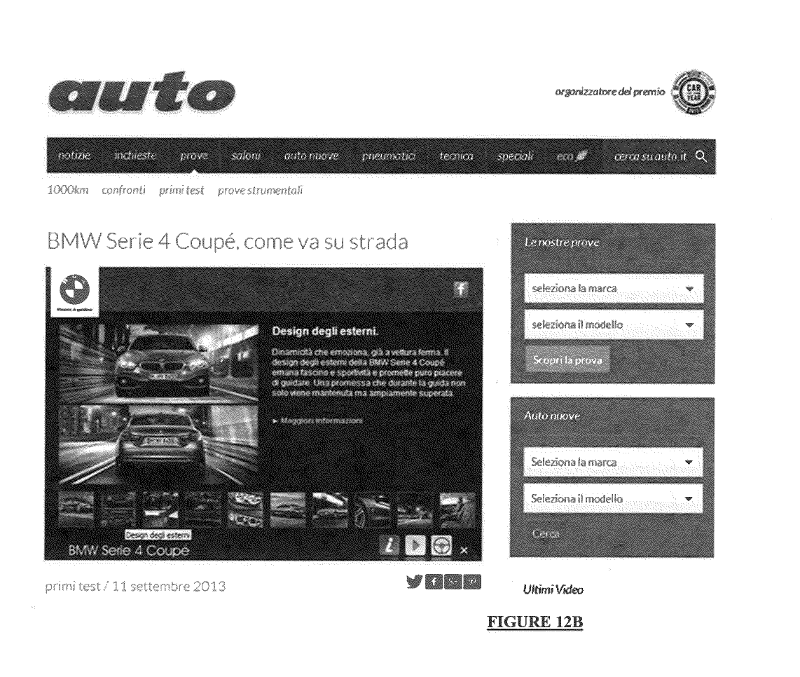

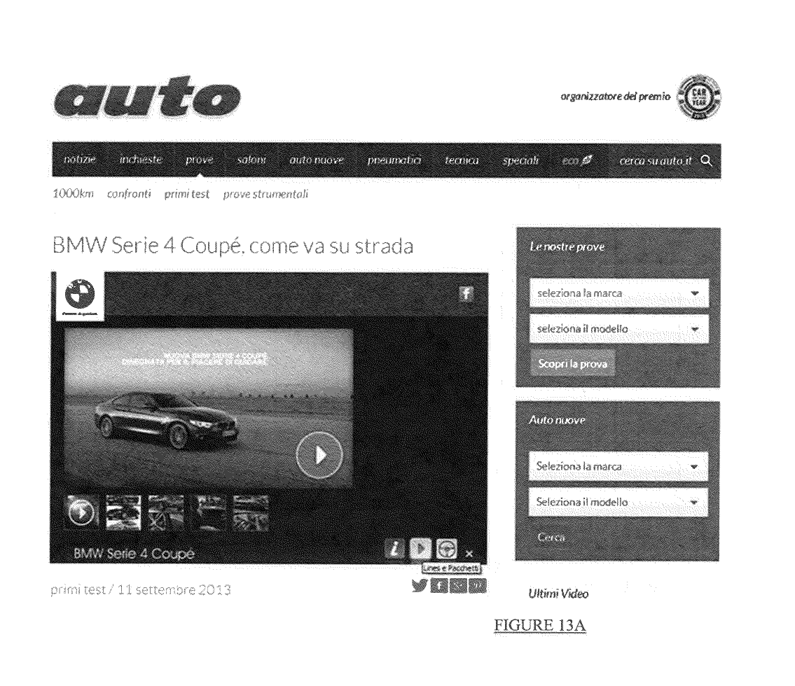

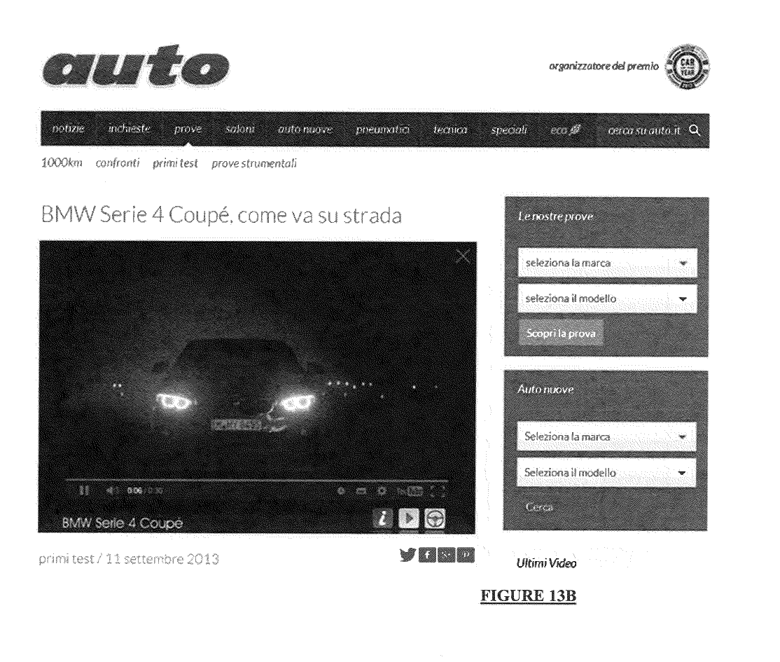

FIGS. 11-13b provide screen shots of various embodiments of the present invention. FIG. 11 provides a screen shot view of an iFrame (In-Image) as it appears on an article image, prior to the user clicking on the image, which shows a black semi-opaque bar with three keys. FIG. 12a provides a screen shot view of an iFrame (In-Image) as it appears on an article image, upon the user clicking on the first “i” key. FIG. 13b provides a screen shot view of an iFrame (In-Image) as it appears on an article image, upon the user clicking on the first “i” key and within the photo gallery. FIG. 13a provides a screen shot view of an iFrame (In-Image) as it appears on an article image, upon the user clicking on the second “play” key. FIG. 13b provides a screen shot view of an iFrame (In-Image) as it appears on an article image, upon the user clicking on the second (‘play’) key and within the photo gallery.

The implementation of this code enables system 100 to provide iFrame source code to those website articles that have been selected by the Account Manager for the running of a campaign and for the duration of the campaign. When a campaign ends (engagement is met), the JavaScript code will stop to serve the iFrame to the specific website article.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprise”, “include”, and conjugations thereof are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A system for the creation, display and management of content units within existing online content comprising:
i) a manager subsystem for receiving content from an end client and creating a content unit from the received content;
ii) an automation subsystem for assigning the content unit to a target website; and
iii) a statistics subsystem for providing statistics associated with use of the content unit at the target website.

2. The system as recited in claim 1, wherein the content received from the end client includes advertising materials.

3. The system as recited in claim 2, wherein the content includes articles.

4. The system as recited in claim 3, wherein the articles can include any combination of text, videos, photos, photogalleries and hyperlinks.

5. The system as recited in claim 1, wherein the manager subsystem creates an iFrame from the content.

6. The system as recited in claim 5, wherein the manager subsystem provides the iFrame to the target website.

7. The system as recited in claim 1, wherein the manager subsystem administers user accounts.

8. The system as recited in claim 1, wherein the manager subsystem creates photos from the content received from the end client.

9. The system as recited in claim 1, wherein the manager subsystem creates photogalleries from the content received from the end client.

10. The system as recited in claim 1, wherein the statistics subsystem provides full campaign statistics to the end client.

11. The system as recited in claim 1, wherein the content provided by the end client includes at least one photo and a thumbnail is automatically created by the manager subsystem for each photo provided.

12. A method for creating, displaying and managing content units within existing online content comprising the steps of:
i) receiving content in a database associated with a manager subsystem from an end client;
ii) creating a content unit from the received content using the manager subsystem;
ii) assigning the content unit to a target website using an automation subsystem; and
iii) providing using a statistics subsystem statistics associated with use of the content unit at the target website.

13. The method as recited in claim 12, wherein the content received from the end client includes advertising materials.

14. The method as recited in claim 13, wherein the content includes articles.

15. The method as recited in claim 14, wherein the articles can include any combination of text, videos, photos, photogalleries and hyperlinks.

16. The method as recited in claim 12, further comprising the step of creating an iFrame from the content using the manager subsystem.

17. The method as recited in claim 16, further comprising the step of providing the iFrame to the target website using the manager subsystem.

18. The method as recited in claim 12, further comprising the step of administering user accounts using the manager subsystem.

19. The method as recited in claim 12, further comprising the step of creating photos from the content received from the end client using the manager subsystem.

20. The method as recited in claim 12, further comprising the step of creating photogalleries from the content received from the end client.

21. The method as recited in claim 12, further comprising the step of providing full campaign statistics to the end client using the statistics subsystem.

22. The method as recited in claim 12, wherein the content provided by the end client includes at least one photo and automatically creating a thumbnail using the manager subsystem for each photo provided.
